(19) United States
(12) Patent Application Publication
(10) Pub. No.: US 2014/0328657 A1
(43) Pub. Date: Nov. 6, 2014

(54) TRAILER WITH MOVEABLE PLATFORM

(71) Applicant: Highcross Designs Limited, Denton, Greater Manchester (GB)

(72) Inventor: David Wyatt, Denton (GB)

(21) Appl. No.: 14/359,431

(22) PCT Filed: Nov. 23, 2012
(86) PCT No.: PCT/GB2012/052906

§ 371 Date: May 20, 2014

(30) Foreign Application Priority Data
Nov. 23, 2011 (GB) 1120214.0

(51) Int. Cl. B60P 1/43; B60P 1/02; B60P 3/11; B62D 63/06

(52) U.S. Cl. CPC B60P 1/431; B62D 63/06; B60P 1/02; B60P 3/11
USPC 414/495; 414/813

(57) ABSTRACT

A trailer having a moveable and rotatable platform.

### TECHNICAL FIELD OF THE INVENTION

The present invention relates to a trailer with a moveable platform, particularly, but not exclusively, one adapted for use in loading and unloading aircraft.

### BACKGROUND TO THE INVENTION

When transporting a large number of articles, it is often appropriate to use a trailer. Trailers are well known and conventionally comprise a chassis, a coupling mechanism, at least two wheels, and a fixed platform.

Trailers are used to transport many different types of goods and are also used at airports throughout the world where they are used to transport luggage and other cargo.

It will be understood that the word “trailer” as used herein is intended to embrace any load-carrying vehicle, or portion of a vehicle, including trailers for demountable attachment to a truck, tractor unit, or other suitable vehicle, and trailers that are fixed to, or integral with, such vehicles.

The trailers used in airports are generally basic flatbed type trailers. Such trailers are very close to the ground to improve stability when loaded with luggage or cargo. However, this presents a difficulty as it is necessary to manually lift each piece of luggage on to a conveyor belt that moves the luggage up into the hold of an aircraft. The lower part of the conveyor belt is conventionally around 1 to 1.5 metres above ground level so each piece of luggage or cargo needs to be lifted over this distance by hand. This requires significant manpower and is also time consuming. There is also an increased danger of the luggage being damaged or the workers being injured.

Furthermore, certain pieces of cargo present particular difficulties, in particular the personal equipment and aids of people with restricted mobility. These mobility aids, for example electric wheelchairs or mobility scooters, can weigh in excess of 400 kg. Presently, such equipment is manually lifted onto the conveyor belts in the same way as conventional luggage or cargo. This presents a serious health and safety issue for workers whose job it is to load and unload the aircraft. Manually moving this equipment onto the conveyor belt is also time consuming and requires considerable manpower which may result in delays for the aircraft. Furthermore, given the weight of the equipment and the difficulty in lifting it onto the conveyor belt, there is a greater likelihood of the equipment falling or being damaged in some other way. The risk of injury to the workers when lifting such heavy equipment is considerable.

The present invention is made from a consideration of these problems.

It is therefore an object of the present invention to provide a trailer which significantly reduces the amount of manual lifting required when loading and unloading an aircraft or other vehicle, specifically when loading heavy equipment. A further object of the present invention is to provide a safer and more efficient way of loading luggage or cargo onto an aircraft or other vehicle.

The present invention may be operated by a single person and reduces the risk of injury to the operator and the risk of damage to the article being loaded. Additionally, the present invention reduces the time required to load an article onto an aircraft or other vehicle.

### SUMMARY OF THE INVENTION

According to a first aspect of the invention, there is provided a trailer having a platform wherein the platform is moveable between a lowered position and a raised position, and wherein the platform is rotatable.

According to a second aspect of the invention, there is provided a method of loading a vehicle, said method involving the use of a trailer having a platform wherein the platform is moveable between a lowered position and a raised position, and wherein the platform is rotatable.

The preferred features of the invention are set out in the dependent claims.

### DETAILED DESCRIPTION OF THE INVENTION

In order that the invention may be more readily understood, specific embodiments thereof will now be described by way of example only with reference to the accompanying drawings in which:

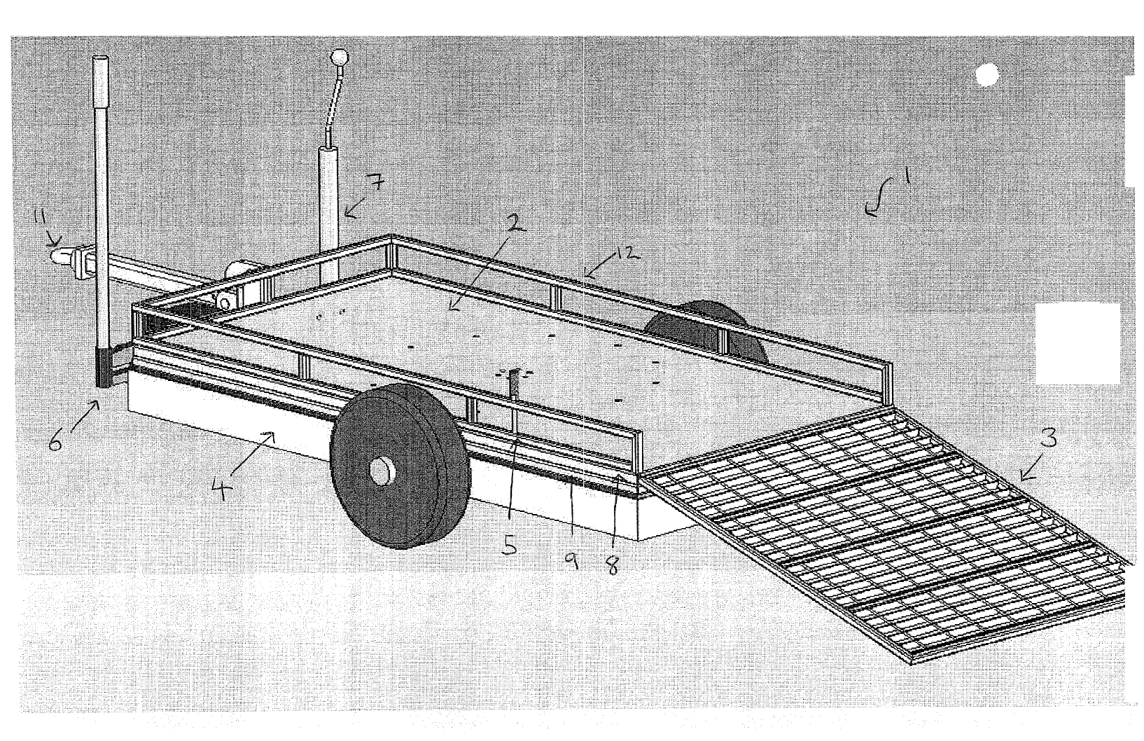

FIG. 1 shows a perspective view of the trailer in a first, lowered position;

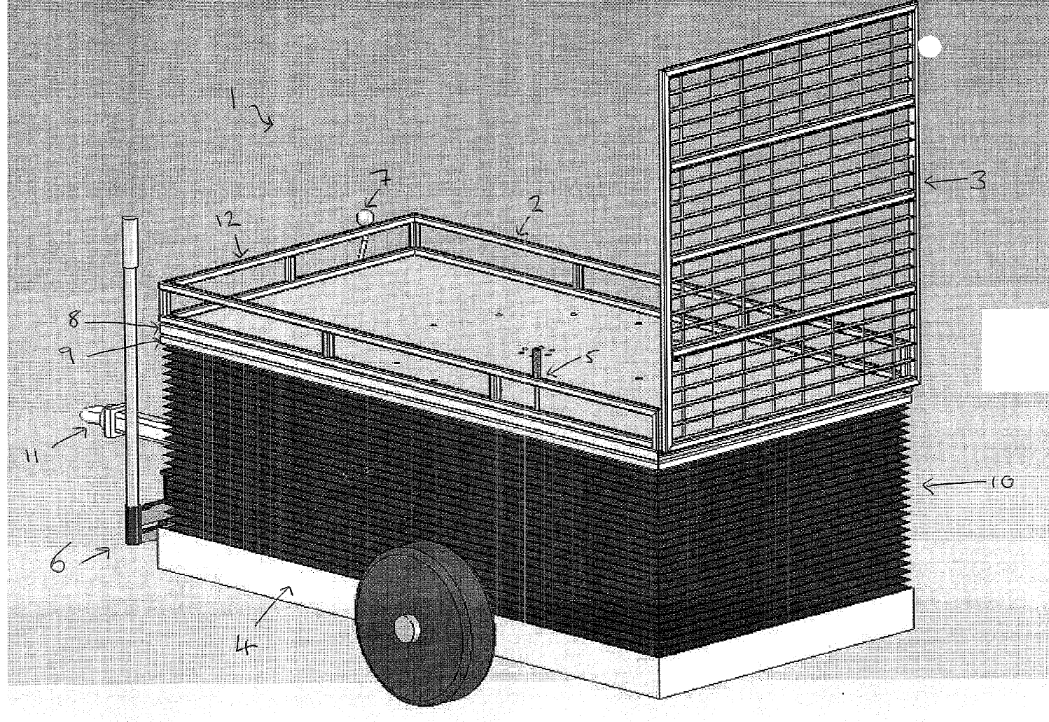

FIG. 2 shows a perspective view of the trailer in a second, raised position;

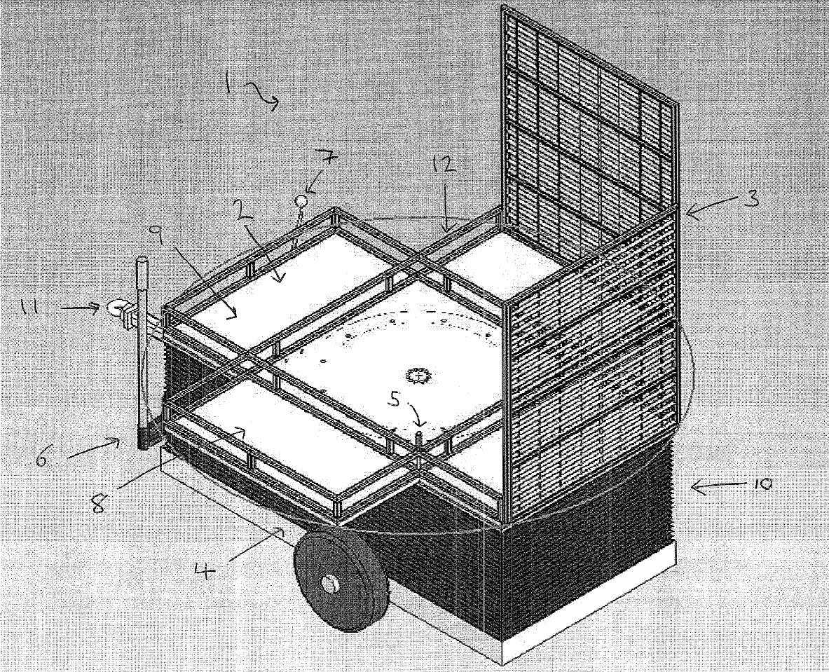

FIG. 3 shows a perspective view of the rotation of the trailer platform;

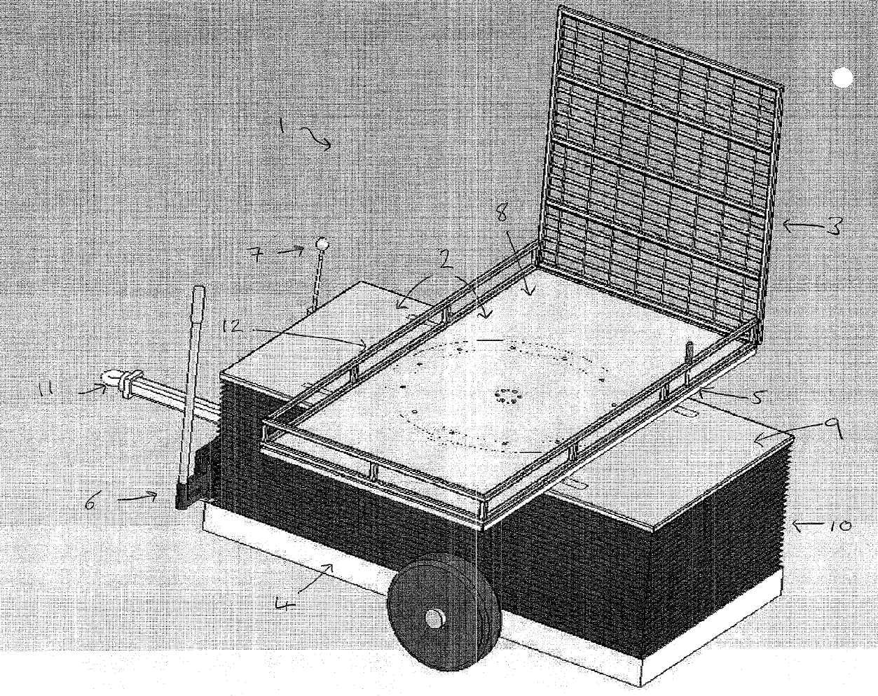

FIG. 4 shows a perspective view of the trailer platform in the rotated position;

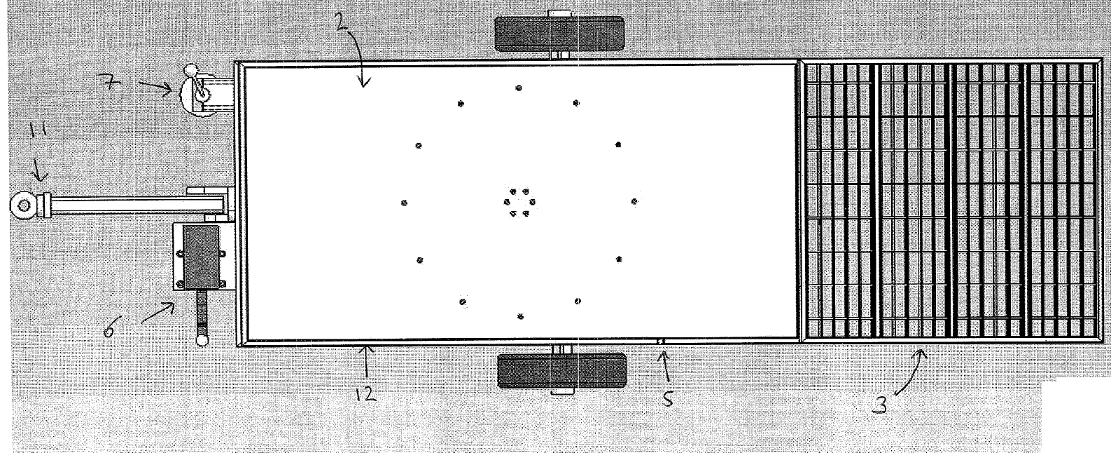

FIG. 5 shows a top view of the trailer in the first, lowered position;

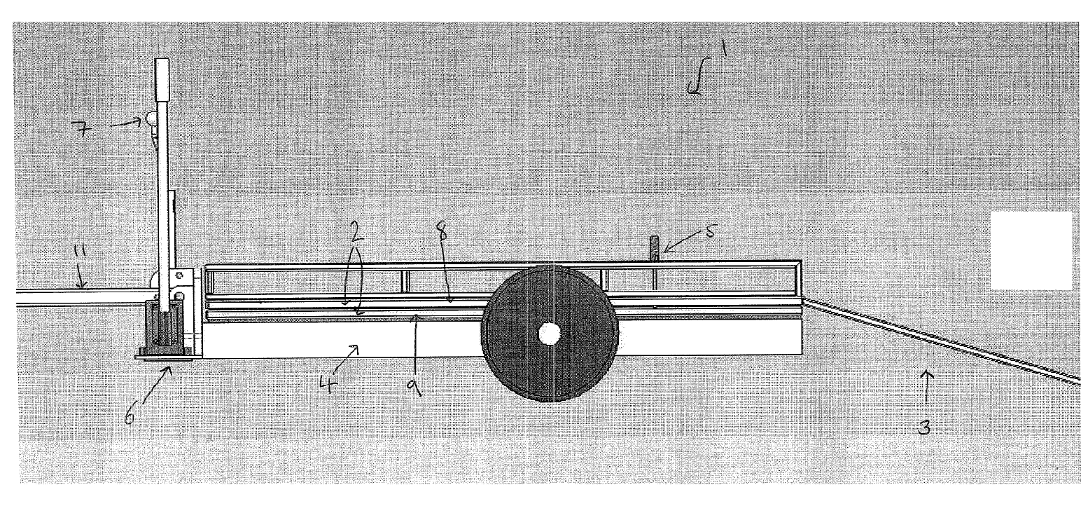

FIG. 6 shows a side view of the trailer in the first, lowered position;

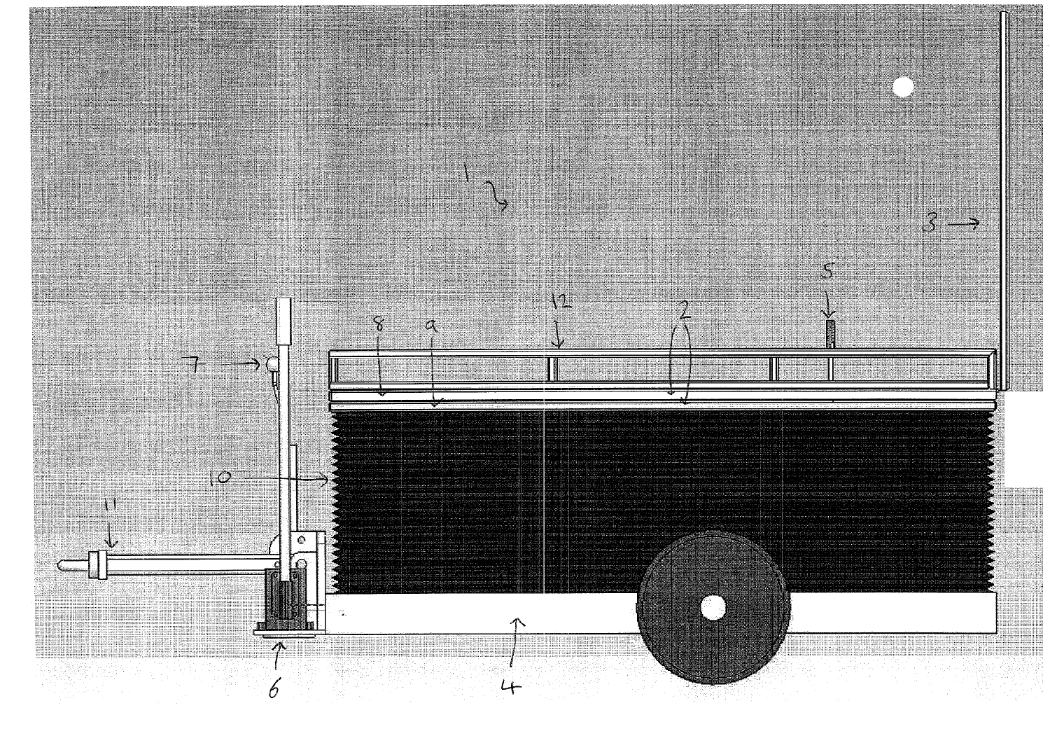

FIG. 7 shows a side view of the trailer in the second, raised position;

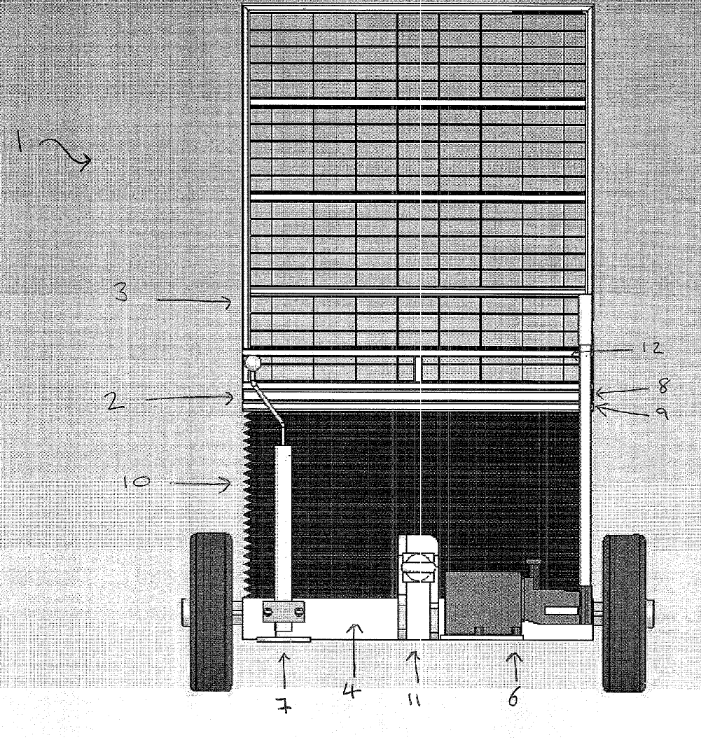

FIG. 8 shows an end view of the trailer in the second, raised position;

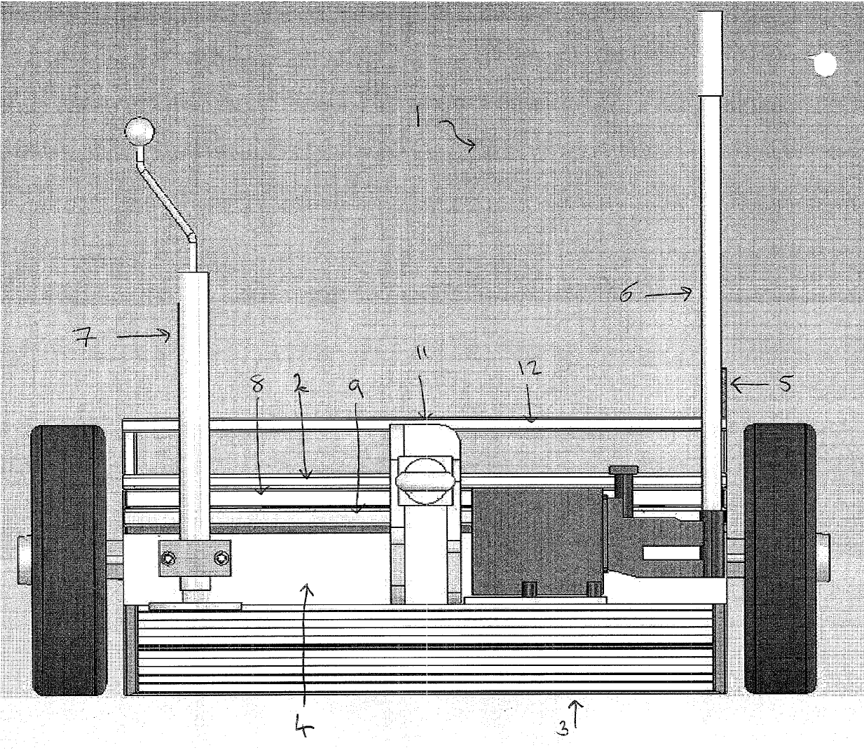

FIG. 9 shows an end view of the trailer in the first, lowered position;

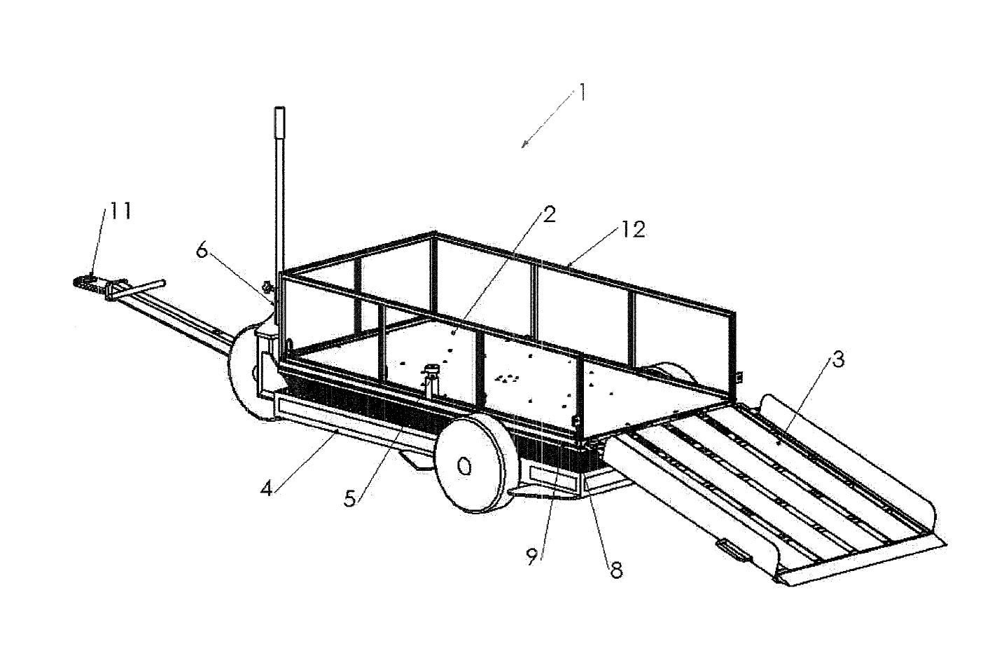

FIG. 10 shows a perspective view of an alternative embodiment of the trailer in a first, lowered position;

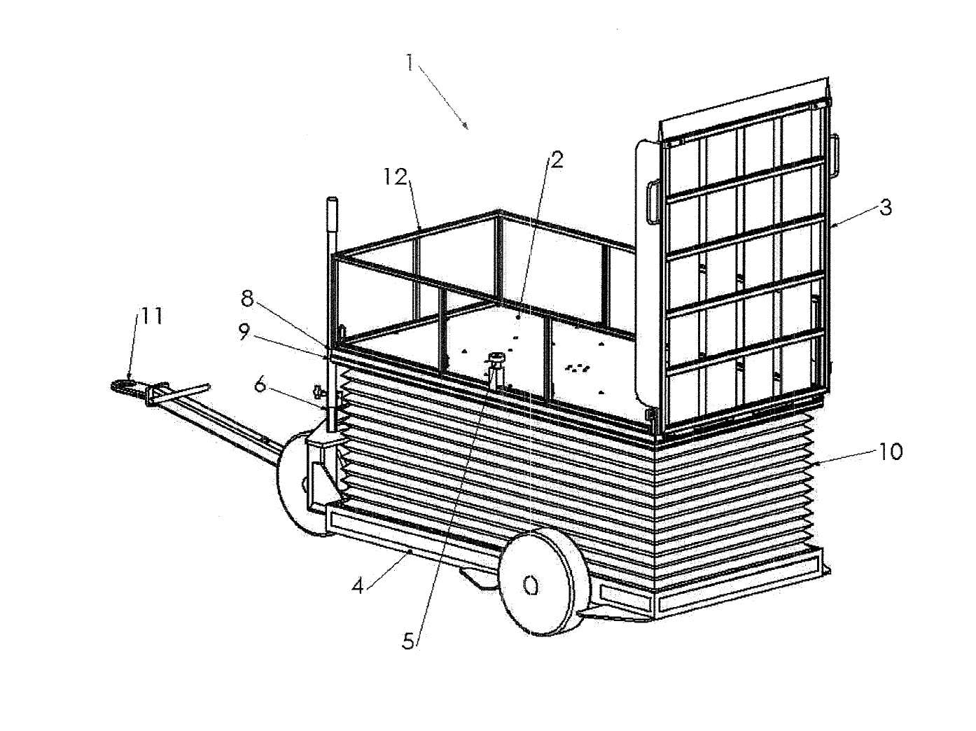

FIG. 11 shows a perspective view of an alternative embodiment of the trailer in a second, raised position;

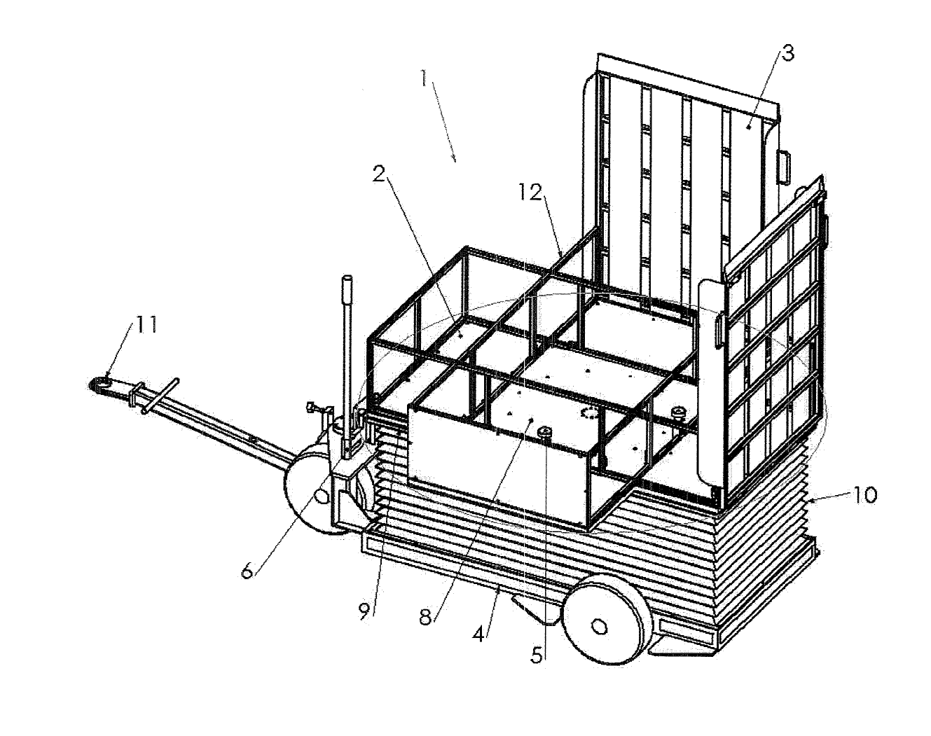

FIG. 12 shows a perspective view of the rotation of the trailer platform in an alternative embodiment;

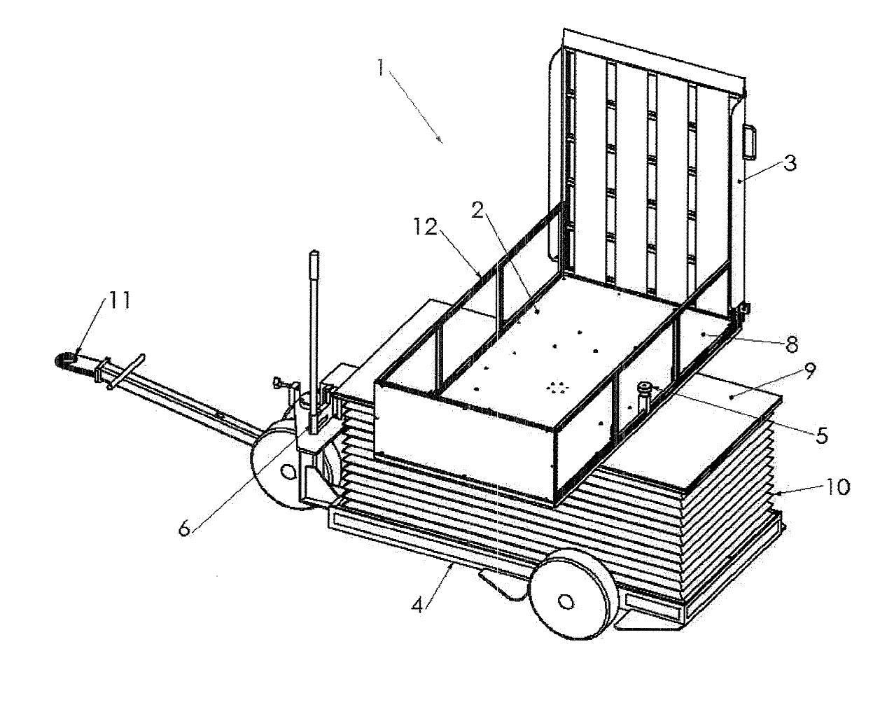

FIG. 13 shows a perspective view of an alternative embodiment of the trailer platform in the rotated position;

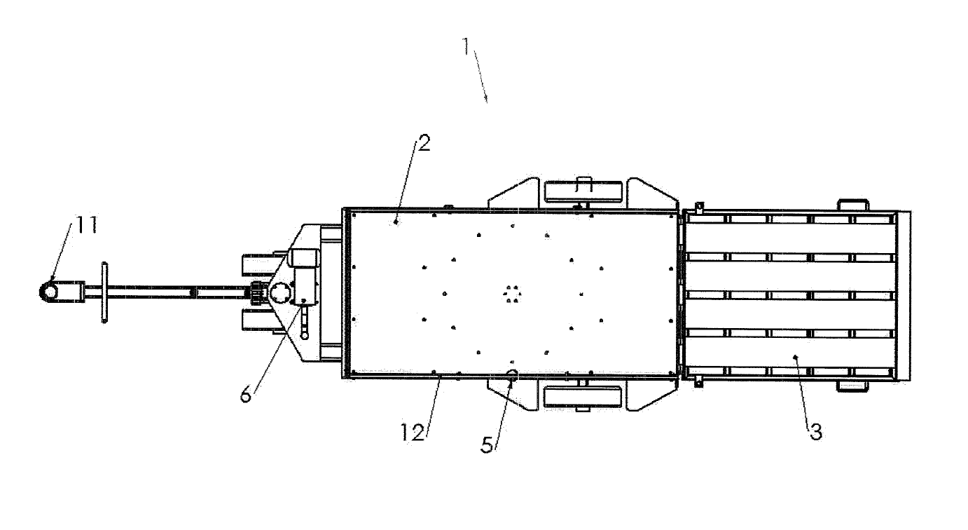

FIG. 14 shows a top view of a alternative embodiment of the trailer in the first, lowered position;

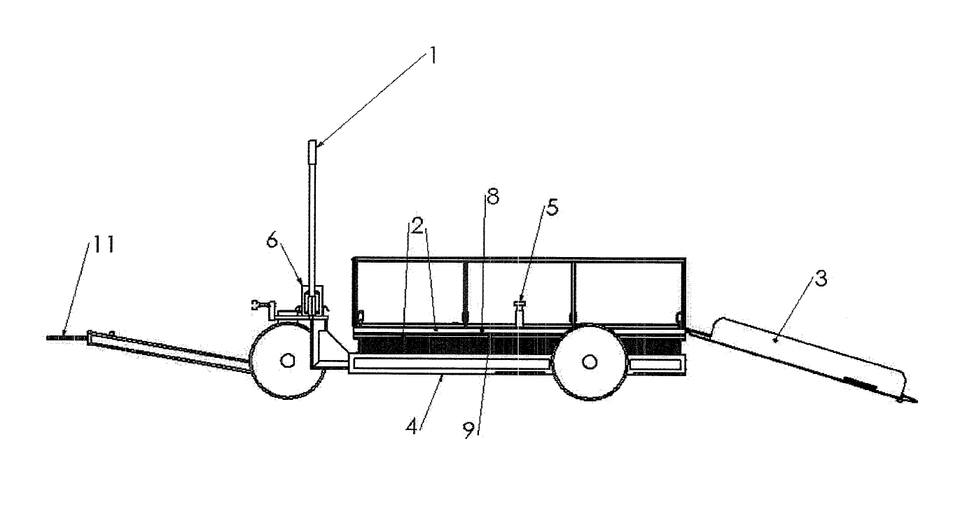

FIG. 15 shows a side view of a alternative embodiment of the trailer in the first, lowered position;

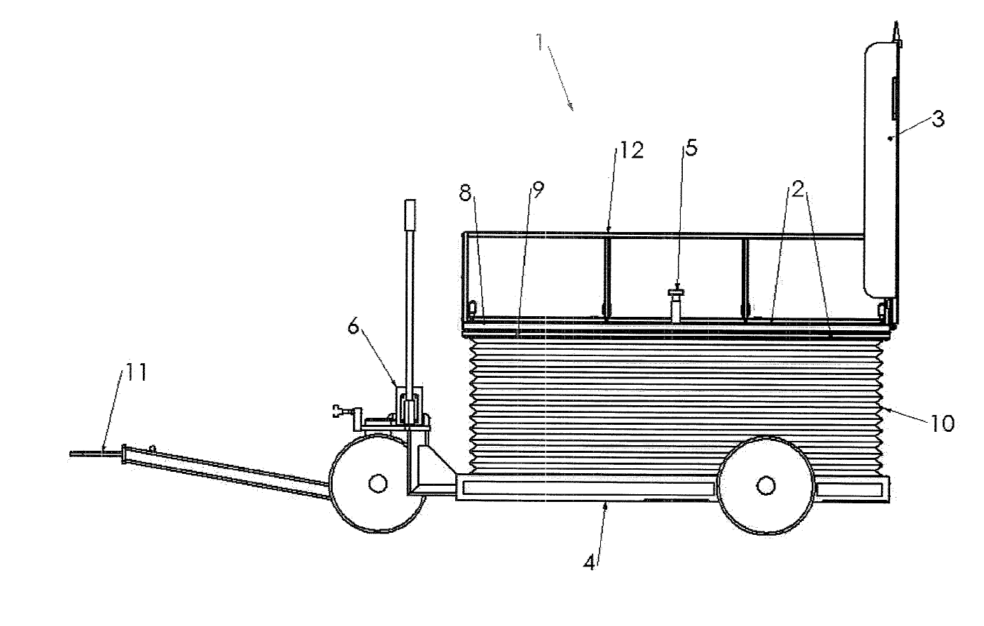

FIG. 16 shows a side view of an alternative embodiment of the trailer in the second, raised position;

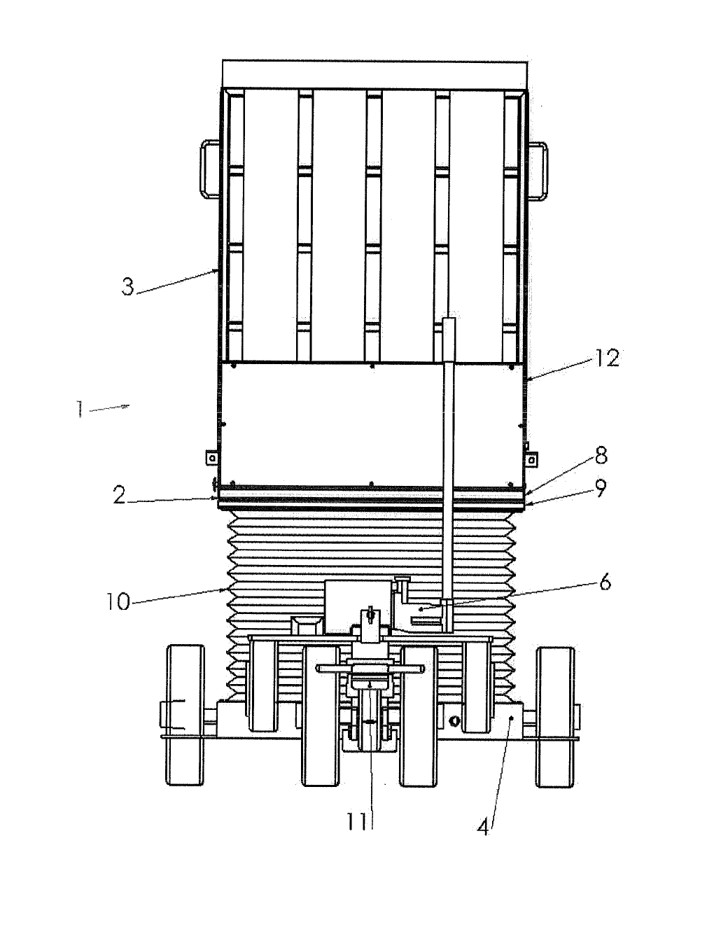

FIG. 17 shows an end view of an alternative embodiment of the trailer in the second, raised position; and

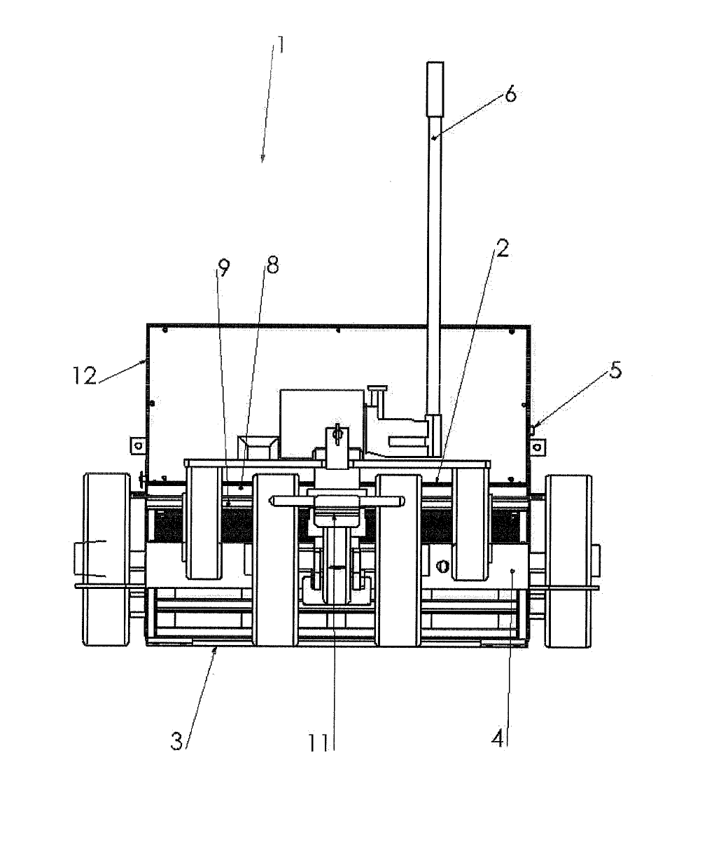

FIG. 18 shows an end view of an alternative embodiment of the trailer in the first, lowered position.

Referring now to the accompanying figures, there is shown in FIG. 1 a trailer generally indicated as 1.

The trailer 1 incorporates a platform (trailer lift table) 2, and a chassis 4. The trailer lift table 2 comprises an upper section 8 and a lower section 9. The upper section 8 is rotatably connected to the lower section 9 such that the upper section 8 can rotate in a horizontal plane with respect to the lower section 9, as illustrated in FIGS. 3 and 4. The upper section 8 and the lower section 9 are stopped from rotating with respect to one another by way of a pin 5. Other suitable means for stopping rotation which may be utilised in place of the pin 5 include latches, straps, bolts, and levers. As illustrated in FIGS. 3 and 4, when the upper section 8 is to be rotated, the pin 5 is disengaged to allow for free rotation of the upper section 8.

The platform 2 is connected to the chassis 4 by way of a raising/lowering mechanism 6 such that the platform 2 is moveable between a lowered position and a raised position. FIGS. 2, 3, 4, 7, 8, 11, 12, 13, 16 and 17 show the platform 2 in the raised position and FIGS. 1, 5, 6, 9, 10, 15 and 18 show the platform 2 in the lowered position. The raising/lowering mechanism 6 may be a manually operated system as illustrated in the accompanying figures, or may be a powered system. The raising/lowering mechanism 6 may be able to raise the platform 2 through a distance of up to 5 metres, preferably up to 3 metres and more preferably up to 2 metres and most preferably up to substantially 1 metre.

The trailer 1 also comprises a ramp 3. The ramp 3 is hingeably connected to the upper section 8 of the platform 2 and is moveable between a first, lowered position wherein the ramp 3 forms a ramp up to the upper section 8 as shown in FIGS. 1, 5, 6, 10, 14 and 15 and a second, raised position wherein the ramp 3 acts as a barrier or rear wall, as shown in FIGS. 2, 3, 4, 7, 8, 11, 12, 13, 16 and 17. There is also provided a barrier or barriers 12 on one or more sides of the platform 2 to provide a barrier or wall around the upper section 8 to prevent the articles loaded on the trailer from falling off. In the illustrated examples, the barrier or barriers 9 are fixed, but they may be moveable in other embodiments. The barriers may be hinged to act as a gate and/or they may be moveable to act as a ramp or ramps. Thus, the trailer may comprise a second or further ramps. The second or further ramps may be connected to the trailer or trailer platform and may be positioned opposite or adjacent to the first ramp. The ramps are preferably hingedly attached to the upper section of the trailer platform. In this manner, the trailer can be used as a bridge. The upper section of the trailer platform or a section thereof may be slidable such that it can be moved in a substantially horizontal direction to allow an object on the trailer to be moved, for example into the hold of an aircraft where a vertical ramp would not fit. The trailer may alternatively comprise a separate slidable section which can be advanced in the same way or the whole platform may be slidable. The slidable section may be extended to allow the object on the trailer to be moved substantially in a horizontal direction. The trailer may also comprise a rise and fall jockey wheel 7 which may be lowered to provide stability. There may also be provided a coupling mechanism 11. In an alternative embodiment, the trailer comprises a pair of wheels attached to a rotatable axle and positioned centrally at the front of the trailer as shown in FIGS. 10 to 18. The axle allows the wheels to be moved to assist with reversing of the trailer. The coupling mechanism 11 may be attached to the axle or the chassis or any other suitable position. The coupling mechanism 11 may comprise a towing hitch. The coupling mechanism 11, when uncoupled, may be moved to lift the front wheels of the trailer off the ground which brakes the trailer.

FIG. 2 shows the trailer lift table 2 in the raised position and also shows the ramp 3 in the raised position. There is a protective skirt 10 fixed between the chassis and the trailer lift table that encloses the area beneath the trailer platform 2 when the trailer platform 2 is raised.

FIGS. 3, 4, 12 and 13 show the upper section 8 being rotated with respect to the lower section 9 when in the raised position. Although these figures indicate the upper section 8 rotating through 90°, the upper section may be rotated through any angle and the lower section 9 may have suitable means with which the pin 5 or equivalent may engage to hold the upper section 8 in position, such as receiving holes.

In use, the ramp 3 is moved into the lowered position such that a ramp up to the trailer platform 2 is formed. The article which is to be loaded onto the trailer 1, such as a personal mobility scooter or electric wheelchair, is transferred up the ramp 3 and onto the trailer 1. Once the article has been loaded, the ramp 3 is moved into its raised position where it forms a barrier to stop the article from falling off the trailer 1. The article may be reversibly attached to the trailer 1 by way of straps or belts to stop the article from moving during transport. The trailer lift table 2 is then raised by way of the raising and lowering mechanism 6 from a first, lowered position to a second, raised position. The pin 5 or other suitable means is then disengaged to allow the upper section 8 of the trailer lift table 2 to rotate with respect to the lower section 9. The upper section 8 is rotated into a second position and the pin is engaged to stop the rotation of the upper section. The ramp 3 is moved into the lowered position. Finally, the article on the trailer 1 is offloaded via the ramp 3. Once unloaded, the ramp 3 is returned to its raised position and the upper section 8 of the trailer platform 2 is rotated back into alignment with the lower section 9 and the pin 5 is re-engaged. Finally, the trailer lift table 2 is lowered into the first, lowered position.

The trailer platform 2 preferably remains substantially horizontal throughout loading and unloading to reduce the risk of any article being transported from moving or potentially falling from the trailer. Furthermore, by having the trailer platform 2 remaining substantially horizontal throughout loading and unloading, especially when the article loaded onto it is heavy or fragile, this reduces the likelihood of injury to the operator or damage to the article.

It is of course to be understood that the invention is not intended to be restricted to the details of the above embodiment which is described by way of example only.

1. A trailer having a platform wherein the platform is moveable between a lowered position and a raised position and wherein the platform is rotatable, and wherein the trailer further comprises a separate ramp.

2. A trailer according to claim 1, wherein the platform comprises a lower section and an upper section.

3. A trailer as claimed in claim 2, wherein the lower section is rotatably connected to the upper section.

4. A trailer as claimed in claim 3, wherein the upper section may be rotated around a central pivot point.

5. A trailer as claimed in claim 2, wherein the upper section and the lower section are reversibly connected to restrict rotation.

6. A trailer as claimed in claim 5, wherein the upper section and the lower section are reversibly connected to restrict rotation by one or more pins.

7. A trailer as claimed in claim 5, wherein the upper section and the lower section are reversibly connected to restrict rotation by latches, straps, bolts, and/or levers.

8. A trailer as claimed in claim 4, wherein the upper section is rotatable through any angle relative to the lower section.

9. A trailer as claimed in claims 6, wherein the lower section comprises means with which the pin may engage to restrict rotation of the upper section.

10. A trailer as claimed in claim 9, wherein the means comprise holes or depressions in the lower section.

11. A trailer as claimed in claim 10, wherein the holes or depressions are concentric with the central pivot point.

12. A trailer as claimed in claim 11, wherein the holes or depressions are spaced regularly and allow the upper section to be locked at various predetermined angles with respect to the lower section.

13. A trailer as claimed in claim 1, wherein the trailer comprises a raising and lowering mechanism.

14. A trailer as claimed in claim 13, wherein the trailer further comprises a chassis and the raising and lowering mechanism connects the chassis and the platform.

15. A trailer as claimed in claim 13, wherein the raising and lowering mechanism is manually operated.

16. A trailer as claimed in claim 13, wherein the raising and lowering mechanism is electrically, hydraulically, or mechanically operated.

17. A trailer as claimed in claim 2, wherein the upper section and the lower section may be rotated with respect to one another by manual or by powered means.

18. A trailer as claimed in claim 17, wherein the powered means comprise electronic, hydraulic, or mechanical means.

19. A trailer as claimed in claim 1, wherein the ramp is hingeably connected to the trailer.

20. A trailer as claimed in claim 19, wherein the ramp is hingeably connected to the platform and is moveable between a lowered position and a raised position.

21. A trailer as claimed in claim 19, wherein the ramp is moved by manual or by powered means.

22. A trailer as claimed in claim 1, wherein the trailer also comprises a rise and fall jockey wheel, or a pair of wheels attached to an axle at the front of the trailer.

23. A trailer as claimed in claim 1, wherein the trailer comprises a coupling mechanism.

24. A trailer as claimed in claim 1, wherein the trailer comprises at least two wheels.

25. A trailer as claimed in claim 1, wherein there is a barrier on one or more sides of the upper section of the platform.

26. A trailer as claimed in claim 25, wherein the barrier is fixed.

27. A trailer as claimed in claim 25, wherein the barrier is fully or partially moveable.

28. A trailer as claimed in claim 1, wherein the trailer comprises a chassis and there is a protective skirt connected between the chassis and the platform.

29. A trailer as claimed in claim 1, wherein there are securing means on the upper section of the platform.

30. A trailer as claimed in claim 29, wherein the securing means comprise straps, belts, clips, ties, clamps or other suitable securing means.

31. A trailer as claimed in claim 1, wherein the ramp is slidably connected to the trailer.

32. A trailer as claimed in claim 31, wherein the ramp is stowed within or below the platform.

33. A trailer as claimed in claim 1, wherein the trailer is suitable for loading of persons of restricted mobility on their mobility aids.

34. A method of loading a vehicle, said method involving the use of an apparatus having a platform wherein the platform is moveable between a lowered position and a raised position and wherein the platform is rotatable, and wherein the trailer further comprises a separate ramp.

35. (canceled)
